(19) United States
(12) Patent Application Publication
(10) Pub. No.: US 2026/0140629 A1
(43) Pub. Date: May 21, 2026

(54) DATA PREFETCHING METHOD AND DEVICE

(71) Applicant: SAMSUNG ELECTRONICS CO., LTD., Suwon-si (KR)

(72) Inventors: LEI GENG, Suwon-si (KR); PAN YANG, Suwon-si (KR); JIHUN HAM, Suwon-si (KR); NAKWON LEE, Suwon-si (KR); SUNG-HYUN CHO, Suwon-si (KR); XING HE, Suwon-si (KR)

(73) Assignee: SAMSUNG ELECTRONICS CO., LTD., Suwon-si (KR)

(21) Appl. No.: 19/089,696

(22) Filed: Mar. 25, 2025

(30) Foreign Application Priority Data
Nov. 21, 2024 (CN) 202411676626.4

(51) Int. Cl. G06F 3/06

(52) U.S. Cl. CPC G06F 3/0611; G06F 3/0659; G06F 3/0679

(57) ABSTRACT

Provided is a data prefetching method and device, the data prefetching method including acquiring parameters of read requests for a storage device within a prefetching time window, wherein the parameters of the read requests include at least a feature of the read requests and logical block address information of the read requests; determining, based on the feature of the read requests, a prefetching quantity of subsequent read requests for the storage device; determining, based on the logical block address information of the read requests, a prefetching quantity of prefetching chunk addresses for the subsequent read requests; and prefetching data in the prefetching quantity of the prefetching chunk addresses of the storage device.

### CROSS-REFERENCE TO RELATED APPLICATION

This application claims priority to Chinese Patent Application No. 202411676626.4, filed on Nov. 21, 2024, the contents of which are hereby incorporated by reference in its entirety.

### BACKGROUND

### 1. Field

The present disclosure relates of the use of artificial intelligence in the field of storage technology. More particularly, the present disclosure relates to a data prefetching method and device.

### 2. Description of Related Art

In order to improve data reading efficiency, many caches may be included in various layers of a system, and various prefetching technologies may be used to improve cache hit rate. Related prefetching technologies can be broadly categorized into two types: rule-based prefetching technology, such as time-based and space-based; and machine learning-based prefetching technology. However, these two technologies have their own disadvantages. Although the rule-based prefetching technology is simple and easy to realize, its accuracy is relatively low. Although the prefetching accuracy of the machine learning-based prefetching technology compared to the rule-based prefetching technology has been greatly improved, realization is troublesome and limited because machine learning algorithms require a large number of storage and computational resources. With development of new devices, caches have been deployed on the device side in order to accelerate the device, and identifying methods to improve the hit rate of such caches is desirable.

A Compute Express Link (CXL) interface is an open standard for high-speed, high-capacity connections between processors and memory. A Memory Semantics (MS)-Solid State Disk (SSD) is a new type of storage device or equipment developed by utilizing the Compute Express Link interface. Memory Semantics-Solid State Disks may be configured with a large-capacity NAND flash and a corresponding-capacity Dynamic Random Access Memory (Dynamic Random Access Memory). The Memory Semantics-Solid State Disk can be used in three modes: a high-performance mode, a persistent memory mode, and a hierarchical memory mode, which are suitable for different application scenarios through the Compute Express Link interface.

In the high-performance mode, a Dynamic Random Access Memory (DRAM) can be used as a cache for the underlying NAND Flash, and block-based write requests can be sent down to the Memory Semantics-Solid State Disk through the CXL. IO interface. A Byte-based read request can be sent down to the Memory Semantics-Solid State Drive through the CXL. MEM interface. At this point, the read request can first determine whether the data is in the Dynamic Random Access Memory Cache (DRAM Cache), and then return the data directly if the request hits the cache, thus improving the processing speed of the read request and reducing latency.

The rule-based prefetching technology can be simply categorized into two types: time rule-based and space rule-based. The premise of the time rule-based is that the application's data access has high time relevance. For example, based on the time locality principle, the data to be accessed can be the data that is currently being accessed. For such applications, data can be prefetched into the cache using time prefetching technology. The premise of spatial rule-based is that the applications make extensive use of data objects with regular and fixed layouts, which leads to recurring access patterns on memory regions. Space data prefetching technology utilizes this phenomenon to prefetch future memory references and hide the long latency of NAND flash accesses. The rule-based prefetching technology is simple and easy to implement, but the accuracy of the prefetching is poor, ranging from 9% to 76%.

One machine learning-based prefetching technology treats prefetching as a classification problem for sequence prediction. This machine learning-based prefetching technology uses fine-grained address segments as inputs to reduce vocabulary and uses incremental bitmaps for multiple outputs to predict a set of unordered future addresses. This machine learning-based prefetching technology is based on the relationship between the inputs and outputs of an attention-based network in learning mapping. This machine learning-based prefetching technology improves the accuracy of prefetching, but has very demanding requirements on computational resources.

In summary, both of the above prefetching technologies are not suitable for use in the Memory Semantic-Solid State Disk.

### SUMMARY

Provided is a data prefetching method and device including a prefetching technology with low computational resource requirements and high cache hit rates.

According to an aspect of the disclosure, a data prefetching method includes: acquiring parameters of read requests for a storage device within a prefetching time window, wherein the parameters of the read requests include at least a feature of the read requests and logical block address information of the read requests; determining, based on the feature of the read requests, a prefetching quantity of subsequent read requests for the storage device; determining, based on the logical block address information of the read requests, a prefetching quantity of prefetching chunk addresses for the subsequent read requests; and prefetching data in the prefetching quantity of the prefetching chunk addresses of the storage device.

According to an aspect of the disclosure, a data prefetching device includes: a storage device; memory storing one or more instructions; and at least one processor configured to execute the one or more instructions, wherein the one or more instructions, when executed by the at least one processor, cause the data prefetching device to: acquire parameters of read requests for the storage device within a prefetching time window, wherein the parameters of the read requests include at least a feature of the read requests and logical block address information of the read requests, determine, based on the feature of the read requests, a prefetching quantity of subsequent read requests for the storage device, determine, based on the logical block address information of the read requests, the prefetching quantity of prefetching chunk addresses for the subsequent read requests; and prefetch data in the prefetching quantity of the prefetching chunk addresses of the storage device.

According to an aspect of the disclosure, a non-transitory computer readable storage medium has instructions stored therein, which when executed by at least one processor cause the at least one processor to execute a data prefetching method including: acquiring parameters of read requests for a storage device within a prefetching time window, wherein the parameters of the read requests include at least a feature of the read requests and logical block address information of the read requests; determining, based on the feature of the read requests, a prefetching quantity of subsequent read requests for the storage device; determining, based on the logical block address information of the read requests, a prefetching quantity of prefetching chunk addresses for the subsequent read requests; and prefetching data in the prefetching quantity of the prefetching chunk addresses of the storage device.

According to an aspect of the disclosure, a data center system includes: a plurality of application servers; and a plurality of storage servers, wherein each of the plurality of storage servers includes: a storage device; memory storing one or more instructions; and at least one processor configured to execute the one or more instructions, wherein the one or more instructions, when executed by the at least one processor of each of the plurality of storage servers, cause the plurality of storage servers to: acquire parameters of read requests for the storage device of the respective storage server within a prefetching time window, wherein the parameters of the read requests include at least a feature of the read requests and logical block address information of the read requests, determine, based on the feature of the read requests, a prefetching quantity of subsequent read requests for the storage device, determine, based on the logical block address information of the read requests, the prefetching quantity of prefetching chunk addresses for the subsequent read requests; and prefetch data in the prefetching quantity of the prefetching chunk addresses of the storage device.

The data prefetching method and device according to one or more embodiments of the present disclosure, by acquiring parameters of read requests for a storage device within a prefetching time window, wherein the parameters of the read requests include at least a feature of the read requests and logical block address information of the read requests, determining a prefetching quantity of subsequent read requests for the storage device, according to the feature of the read requests, determining the prefetching quantity of prefetching chunk addresses for the subsequent read requests, according to the logical block address information of the read requests, and prefetching data in the prefetching quantity of the prefetching chunk addresses of the storage device, thereby increasing the cache hit rate without increasing the computational resources.

Additional aspects of the general concept of the present disclosure will be explained in the following description, and still others will be clear from the description, or may be known through the implementation of the general concept of the present disclosure.

### BRIEF DESCRIPTION OF DRAWINGS

The above and other aspects and features of the present disclosure will be more apparent from the following description taken in conjunction with the accompanying drawings, in which:

FIG. 1 illustrates a flowchart of a data prefetching method according to one or more embodiments of the present disclosure;

FIG. 2 illustrates a schematic diagram of a data prefetching system according to one or more embodiments of the present disclosure;

FIG. 3 illustrates a block diagram of a data prefetching device according to one or more embodiments of the present disclosure;

FIG. 4 illustrates a schematic diagram of a computing device according to one or more embodiments of the present disclosure;

FIG. 5 is a block diagram illustrating a system to which a storage device is applied according to one or more embodiments of the present disclosure;

FIG. 6 is a schematic diagram illustrating a host storage system according to one or more embodiments of the present disclosure; and

FIG. 7 is a schematic diagram illustrating a data center to which a storage device is applied according to one or more embodiments of the present disclosure.

### DETAILED DESCRIPTION

According to some examples, at least one data prefetching method may provide a prefetching technology with low computational resource requirements and high cache hit rate.

Reference will now be made in detail to one or more embodiments of the present disclosure, examples of which are illustrated in the drawings, wherein the same reference numerals refer to the same members. Embodiments are described below in order to explain the present disclosure by referring to the drawings.

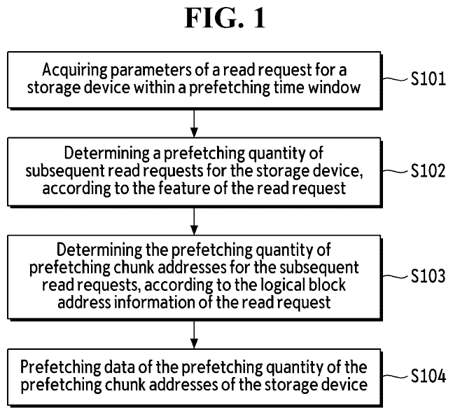

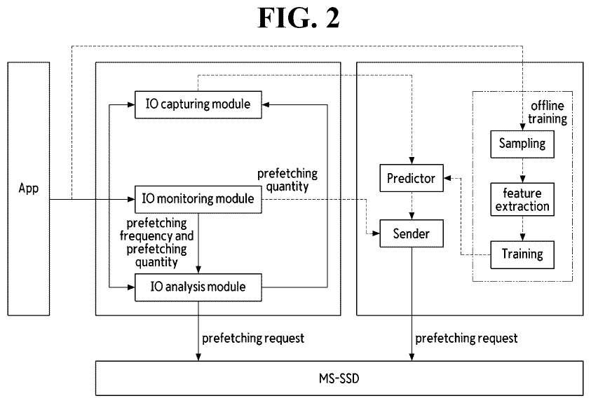

FIG. 1 illustrates a flowchart of a data prefetching method according to one or more embodiments of the present disclosure. FIG. 2 illustrates a structure schematic diagram of a data prefetching system according to one or more embodiments of the present disclosure.

Referring to FIG. 1, in operation S101, parameters of read requests for a storage device within a prefetching time window is acquired. Herein the parameters of the read requests include at least a feature of the read requests and logical block address (LBA) information of the read requests.

In one or more embodiments of the present disclosure, the parameters of the read requests may further include heat information of the read requests.

Specifically, as shown in FIG. 2, read requests using a predetermined interface (e.g., but not limited to, the CXL. MEM interface) may be captured by an input/output (IO) capturing module at a granularity of chunk within a prefetching time window, and parameters such as the features, the logical block address information, and the heat information of these captured read requests may be obtained. The features may be selected using a correlation analysis algorithm, and the heat of the chunk is represented by the quantity of read requests that fall within the chunk. In one or more embodiments of the present disclosure, the feature of the read requests may include, for example, but not limited to, the size, the read and write types, the quantity, the number of bytes, the read and write ratios, the bandwidth, the throughput of the read request, and the like.

In operation S102, a prefetching quantity of subsequent read requests for the storage device is determined according to the feature of the read requests. Here, the subsequent read requests may be read requests that are issued subsequent to the read requests that were subject of operation S101.

In one or more embodiments of the present disclosure, the method may further include determining a prefetching frequency of the subsequent read requests for the storage device, according to the feature of the read requests, and in response dynamically adjust the prefetching frequency and the prefetching quantity to apply to a variety of different workloads. In addition, the dynamic adaptive parameter adjustment function enables the data prefetching method according to one or more embodiments of the present disclosure to be applied in most scenarios without modification.

As an example, as shown in FIG. 2, the input-output strength (total input-output size within the prefetching time window) and the input-output density (a quantity of inputs and outputs within the prefetching time window) of the storage device are monitored by an input-output monitoring module (i.e., the IO monitoring module in FIG. 2). If the input-output strength is high, the prefetching quantity is increased, and if the input-output strength is low, the prefetching quantity is decreased. If the input-output density is high, the prefetching frequency is increased, and if the input-output density is low, the prefetching frequency is decreased. The input-output monitoring module (i.e., the IO monitoring module in FIG. 2) passes the prefetching quantity and the prefetching frequency to the input-output analysis module, and passes the prefetching quantity to the sending module. The prefetching quantity is used to guide the prefetching request as to how many data chunks are prefetched from the flash (e.g., NAND-type flash) of the storage device to the dynamic random access memory cache (DRAM Cache) each time, so as to use different prefetching strategies for different types of workloads to achieve the purpose of reducing power consumption and avoiding resource wastage.

In operation S103, the prefetching quantity of prefetching chunk addresses for the subsequent read requests is determined according to the logical block address information of the read requests. The prefetching quantity of prefetching chunk addresses may be for example, but not limit to 1-100 prefetching chunk addresses. For example, the prefetching quantity of prefetching chunk addresses may be 2, 5, 7, 8, 10 prefetching chunk addresses.

In one or more embodiments of the present disclosure, the determining of the prefetching quantity of the prefetching chunk addresses for the subsequent read requests includes: predicting an attribute of the subsequent read requests based on the logical block address information of the read requests; predicting the prefetching quantity of the prefetching chunk addresses for the subsequent read requests by inputting the heat information of the read requests into a heat prediction model, based on it being predicted that the attribute of the subsequent read requests is a first attribute, thereby determining the prefetching chunk address based on the predicted heat. Herein, the attribute of the subsequent read requests may be a sequential attribute or a random attribute, i.e., indicative of whether the subsequent read requests are sequential or random. For example, the first attribute may be the random attribute.

In one or more embodiments of the present disclosure, the determining of the prefetching quantity of the prefetching chunk addresses for the subsequent read requests may further include: determining the prefetching quantity of the prefetching chunk addresses based on a subsequent logical block address of the logical block address information, based on it being predicted that the attribute of the subsequent read requests is a second attribute, thereby determining the prefetching chunk address based on the logical block address. For example, the second attribute may be the sequential attribute.

As an example, as shown in FIG. 2, the subsequent read requests are predicted to be sequential or random by the input-output analysis module (i.e., the IO analysis module in FIG. 2) according to the logical block address information of the read requests. If the prediction is sequential, the subsequent chunk address is sent directly to the storage device (e.g., Memory Semantics-Solid State Disk (MS-SSD)) in the form of a prefetching request; if the prediction is random, a request is sent to the Input-Output Capture Module to activate the predictor to predict the chunk address to be prefetched.

In one or more embodiments of the present disclosure, the predicting of the prefetching quantity of the prefetching chunk addresses for the subsequent read requests by inputting the heat information of the read requests into the heat prediction model may include: predicting a heat of each chunk address of the storage device by inputting the heat information of the read requests into the heat prediction model; sorting the chunk addresses of the storage device in descending order based on the predicted magnitude of the heat; using the prefetching quantity of the chunk addresses with the greatest heat among the chunk addresses of the storage device as the prefetching chunk addresses, thereby improving the accuracy of the prefetching chunk addresses to improve the prefetching precision.

In one or more embodiments of the present disclosure, the heat prediction model may be obtained by training using the heat of the read requests for the storage device during a predetermined time period as training data.

As an example, as shown in FIG. 2, data collected by the input-output capturing module (i.e., the predictor in FIG. 2) is used by a predictor module (i.e., the predictor in FIG. 2) to predict the heat of a chunk. Firstly, read requests (i.e., workload data) from the storage device over a period of time are collected by the input-output capturer, and the features and the heat information of the read requests are selected to train the heat prediction model in the predictor module (i.e., the predictor in FIG. 2) offline. The heat prediction model (i.e., the predictor in FIG. 2) is then used to predict the heat of each chunk.

In operation S104, data in the prefetching quantity of the prefetching chunk addresses of the storage device is prefetched.

In one or more embodiments of the present disclosure, the prefetching of the data in the prefetching quantity of prefetching chunk addresses may include: prefetching the data in the prefetching quantity of the prefetching chunk addresses of the storage device based on the prefetching frequency, thereby improving the read performance and reducing the read latency.

As an example, as shown in FIG. 2, prefetching quantity of chunks are prefetched by a sender module (i.e., the sender in FIG. 2) by selecting the hottest prefetching quantity of chunks from the chunk heat predicted by the predictor module. These chunk addresses are sent to a storage device (e.g., Memory Semantics-Solid State Disk (MS-SSD)) in the form of the prefetching request through a predetermined interface (e.g., but not limited to, the CXL. IO interface). A prefetching controller of the storage device (e.g., Memory Semantics-Solid State Drive (MS-SSD)) processes the prefetching request and copies the data from the NAND flash of the storage device to the Dynamic Random Access Memory Cache (DRAM Cache).

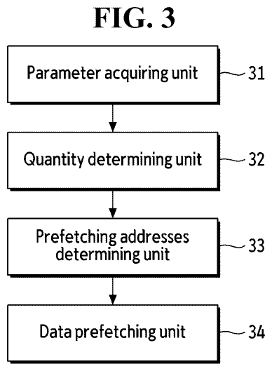

The data prefetching method according to embodiments of the present disclosure has been described above in conjunction with FIG. 1 and FIG. 2. Hereinafter, the data prefetching device according to embodiments of the present disclosure will be described with reference to FIG. 3.

FIG. 3 illustrates a block diagram of a data prefetching device according to one or more embodiments of the present disclosure.

Referring to FIG. 3, the data prefetching device includes a parameter acquiring unit 31, a quantity determining unit 32, a prefetching addresses determining unit 33, and a data prefetching unit 34.

The parameter acquiring unit 31 is configured to acquire parameters of read requests for a storage device within a prefetching time window, wherein the parameters of the read requests include at least a feature of the read requests and logical block address information of the read requests.

In one or more embodiments of the present disclosure, the parameters of the read requests may further include heat information of the read requests.

The quantity determining unit 32 is configured to determine a prefetching quantity of subsequent read requests for the storage device, according to the feature of the read requests.

In one or more embodiments of the present disclosure, the data prefetching device may further include: a prefetching frequency determining unit, configured to determine a prefetching frequency of the subsequent read requests for the storage device, according to the feature of the read requests.

The prefetching addresses determining unit 33 is configured to determine the prefetching quantity of prefetching chunk addresses for the subsequent read requests, according to the logical block address information of the read requests. The prefetching quantity of prefetching chunk addresses may be for example, but not limit to 1-100 prefetching chunk addresses. For example, the prefetching quantity of prefetching chunk addresses may be 2, 5, 7, 8, 10 prefetching chunk addresses.

In one or more embodiments of the present disclosure, in a case where the parameters of the read requests further include the heat information of the read requests, the prefetching addresses determining unit 33 may be configured to: predict an attribute of the subsequent read requests based on the logical block address information of the read requests; and, based on predicting that the attribute of the subsequent read requests is a first attribute, predict the prefetching quantity of the prefetching chunk addresses for the subsequent read requests by inputting the heat information of the read requests into a heat prediction model.

In one or more embodiments of the present disclosure, the prefetching addresses determining unit 33 may be further configured to: predict a heat of each chunk address of the storage device by inputting the heat information of the read requests into the heat prediction model; sort the chunk addresses of the storage device in descending order based on the magnitude of the heat; use the prefetching quantity of the chunk addresses with the greatest heat among the chunk addresses of the storage device as the prefetching chunk addresses.

In one or more embodiments of the present disclosure, the heat prediction model may be obtained by training using the heat of the read requests for the storage device during a predetermined time period as training data.

In one or more embodiments of the present disclosure, the prefetching addresses determining unit 33 may be further configured to: determine the prefetching quantity of the prefetching chunk addresses based on a subsequent logical block address of the logical block address information, based on it being predicted that the attribute of the subsequent read requests is a second attribute. The prefetching quantity of prefetching chunk addresses may be for example, but not limit to 1-100 prefetching chunk addresses. For example, the prefetching quantity of prefetching chunk addresses may be 2, 5, 7, 8, 10 prefetching chunk addresses.

The data prefetching unit 34 is configured to prefetch data in the prefetching quantity of the prefetching chunk addresses of the storage device.

In one or more embodiments of the present disclosure, in case that the data prefetching device include a prefetching frequency determining unit the data prefetching unit 34 may be configured to: prefetching the data in the prefetching quantity of the prefetching chunk addresses of the storage device based on the prefetching frequency.

In addition, according to embodiments of the present disclosure, there also provides a non-transitory computer-readable storage medium having a computer program stored thereon, and when the computer program is executed, the data prefetching method according to embodiments of the present disclosure is implemented.

In one or more embodiments of the present disclosure, the computer-readable storage medium may carry one or more programs that, when executed, may implement the following operations: acquiring parameters of read requests for a storage device within a prefetching time window, wherein the parameters of the read requests include at least a feature of the read requests and logical block address information of the read requests; determining a prefetching quantity of subsequent read requests for the storage device, according to the feature of the read requests; determining the prefetching quantity of prefetching chunk addresses for the subsequent read requests, according to the logical block address information of the read requests; prefetching data in the prefetching quantity of the prefetching chunk addresses of the storage device.

The computer-readable storage medium may be, for example, but not limited to, an electrical, magnetic, optical, electromagnetic, infrared, or semiconductor system, apparatus or device, or any combination of the above. More specific examples of computer-readable storage medium may include, but are not limited to: electrical connections with one or more wires, portable computer disks, hard disks, random access memory (RAM), read only memory (ROM), erasable programmable read only memory (EPROM or flash), optical fiber, portable compact disk read only memory (CD-ROM), optical storage devices, magnetic storage devices, or any suitable combination of the above. In one or more embodiments of the present disclosure, a computer-readable storage medium may be any tangible medium that contains or stores a computer program that may be used by or in conjunction with an instruction execution system, apparatus, or device. The computer program contained on the computer-readable storage medium may be transmitted using any appropriate medium, including but not limited to wire, fiber optic cable, RF (radio frequency), etc., or any suitable combination of the above. The computer-readable storage medium may be included in any device, and it may also exist alone without being incorporated into the device.

In addition, according to embodiments of the present disclosure, there is also provided a computer program product, wherein instructions in the computer program product may be executed by a processor of the computer device to complete the data prefetching method according to embodiments of the present disclosure.

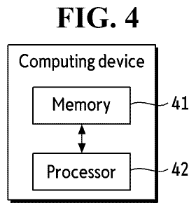

The data prefetching device according to embodiments of the present disclosure has been described above in conjunction with FIG. 3. Next, a computing device according to embodiments of the present disclosure will be described in conjunction with to FIG. 4.

FIG. 4 illustrates a schematic diagram of a computing device according to embodiments of the present disclosure.

Referring to FIG. 4, a computing device 4 according to embodiments of the present disclosure may include a memory 41 and a processor 42, and the memory 41 stores a computer program. When the computer program is executed by the processor 42, the data prefetching method according to embodiments of the present disclosure is implemented.

In one or more embodiments of the present disclosure, when the computer program is executed by the processor 42, the following operations may be implemented: acquiring parameters of read requests for a storage device within a prefetching time window, wherein the parameters of the read requests include at least a feature of the read requests and logical block address information of the read requests; determining a prefetching quantity of subsequent read requests for the storage device, according to the feature of the read requests; determining the prefetching quantity of prefetching chunk addresses for the subsequent read requests, according to the logical block address information of the read requests; prefetching data in the prefetching quantity of the prefetching chunk addresses of the storage device.

The computing device in one or more embodiments of the present disclosure may include, but are not limited to, devices such as a mobile telephone, a laptop, a PDA (personal digital assistant), a PAD (tablet computer), a desktop computer, etc. The computing device shown in FIG. 4 is only an example, and should not impose any limitation on the function and scope of use of embodiments of the present disclosure.

The data prefetching method and device according to embodiments of the present disclosure have been described above with reference to FIGS. 1-4. However, it should be understood: the data prefetching device shown in FIG. 3 may be respectively configured as software, hardware, firmware or any combination of the above to perform specific functions, and the computing device shown in FIG. 4 is not limited to including the above shown components, but some components may be added or deleted according to needs, and the above components may also be combined.

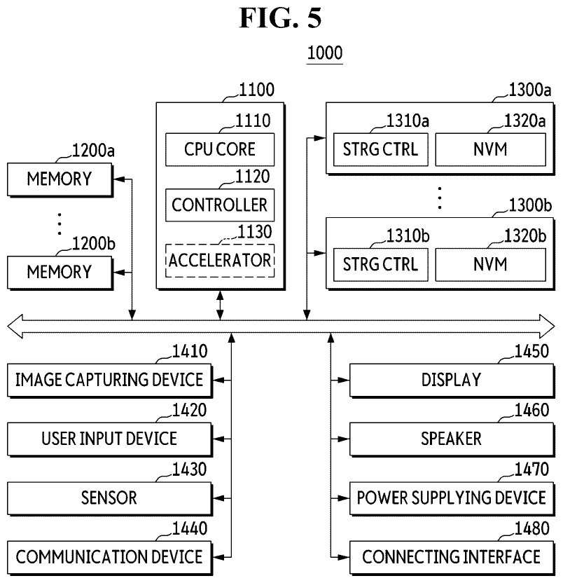

FIG. 5 is a diagram illustrating a system 1000 to which a storage device is applied according to one or more embodiments of the present disclosure. The system 1000 of FIG. 5 may basically be a mobile system, such as a portable communication terminal (e.g., a mobile phone), a smartphone, a tablet personal computer (PC), a wearable device, a healthcare device, or an Internet of things (IOT) device. However, the system 1000 of FIG. 1 is not necessarily limited to the mobile system and may be a PC, a laptop computer, a server, a media player, or an automotive device (e.g., a navigation device).

Referring to FIG. 5, the system 1000 may include a main processor 1100, memories (e.g., 1200a and 1200b), and storage devices (e.g., 1300a and 1300b). In addition, the system 1000 may include at least one of an image capturing device 1410, a user input device 1420, a sensor 1430, a communication device 1440, a display 1450, a speaker 1460, a power supplying device 1470, and a connecting interface 1480.

The main processor 1100 may control all operations of the system 1000, more specifically, operations of other components included in the system 1000. The main processor 1100 may be implemented as a general-purpose processor, a dedicated processor, or an application processor.

The main processor 1100 may include at least one CPU core 1110 and further include a controller 1120 configured to control the memories 1200a and 1200b and/or the storage devices 1300a and 1300b. In some example embodiments, the main processor 1100 may further include an accelerator 1130, which is a dedicated circuit for a high-speed data operation, for example, an artificial intelligence (AI) data operation. The accelerator 1130 may include a graphics processing unit (GPU), a neural processing unit (NPU) and/or a data processing unit (DPU) and be implemented as a chip that is physically separate from the other components of the main processor 1100.

The memories 1200a and 1200b may be used as main memory devices of the system 1000. Although each of the memories 1200a and 1200b may include a volatile memory, such as static random access memory (SRAM) and/or dynamic RAM (DRAM), each of the memories 1200a and 1200b may include non-volatile memory, such as a flash memory, phase-change RAM (PRAM) and/or resistive RAM (RRAM). The memories 1200a and 1200b may be implemented in the same package as the main processor 1100.

The storage devices 1300a and 1300b may serve as non-volatile storage devices configured to store data regardless of whether power is supplied thereto, and have larger storage capacity than the memories 1200a and 1200b. The storage devices 1300a and 1300b may respectively include storage controllers(STRG CTRL) 1310a and 1310b and NVM(Non-Volatile Memory)s 1320a and 1320b configured to store data via the control of the storage controllers 1310a and 1310b. Although the NVMs 1320a and 1320b may include flash memories having a two-dimensional (2D) structure or a three-dimensional (3D) V-NAND structure, the NVMs 1320a and 1320b may include other types of NVMs, such as PRAM and/or RRAM.

The storage devices 1300a and 1300b may be physically separated from the main processor 1100 and included in the system 1000 or implemented in the same package as the main processor 1100. In addition, the storage devices 1300a and 1300b may have types of solid-state devices (SSDs) or memory cards and be removably combined with other components of the system 100 through an interface, for example, the connecting interface 1480 that will be described below. The storage devices 1300a and 1300b may be devices to which a standard protocol, for example, a universal flash storage (UFS), an embedded multi-media card (eMMC), or a non-volatile memory express (NVMe) is applied, without being limited thereto.

The image capturing device 1410 may capture still images or moving images. The image capturing device 1410 may include a camera, a camcorder, and/or a webcam.

The user input device 1420 may receive various types of data input by a user of the system 1000 and include a touch pad, a keypad, a keyboard, a mouse, and/or a microphone.

The sensor 1430 may detect various types of physical quantities, which may be acquired from the outside of the system 1000, and convert the detected physical quantities into electric signals. The sensor 1430 may include a temperature sensor, a pressure sensor, an illuminance sensor, a position sensor, an acceleration sensor, a biosensor, and/or a gyroscope sensor.

The communication device 1440 may transmit and receive signals between other devices outside the system 1000 according to various communication protocols. The communication device 1440 may include an antenna, a transceiver, and/or a modem.

The display 1450 and the speaker 1460 may serve as output devices configured to respectively output visual information and auditory information to the user of the system 1000.

The power supplying device 1470 may appropriately convert power supplied from a battery embedded in the system 1000 and/or an external power source, and supply the converted power to each of components of the system 1000.

The connecting interface 1480 may provide connection between the system 1000 and an external device, which is connected to the system 1000 and capable of transmitting and receiving data to and from the system 1000. The connecting interface 1480 may be implemented by using various interface schemes, such as advanced technology attachment (ATA), serial ATA (SATA), external SATA (e-SATA), small computer small interface (SCSI), serial attached SCSI (SAS), peripheral component interconnection (PCI), PCI express (PCIe), NVMe, IEEE 1394, a universal serial bus (USB) interface, a secure digital (SD) card interface, a multi-media card (MMC) interface, an eMMC interface, a UFS interface, an embedded UFS (eUFS) interface, and a compact flash (CF) card interface.

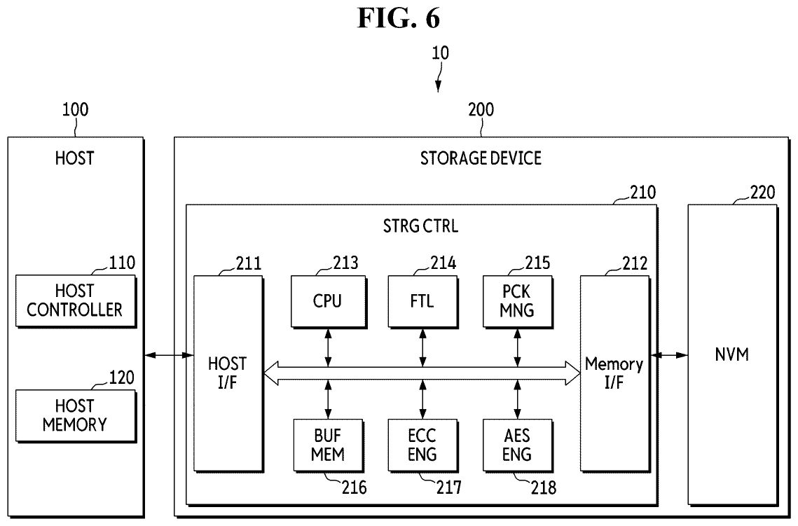

FIG. 6 is a block diagram illustrating a host storage system 10 according to one or more embodiments of the present disclosure.

The host storage system 10 may include a host 100 and a storage device 200. Further, the storage device 200 may include a storage controller 210 and an NVM 220. According to an example embodiment of the present disclosure, the host 100 may include a host controller 110 and a host memory 120. The host memory 120 may serve as a buffer memory configured to temporarily store data to be transmitted to the storage device 200 or data received from the storage device 200.

The storage device 200 may include storage media configured to store data in response to requests from the host 100. As an example, the storage device 200 may include at least one of an SSD, an embedded memory, and a removable external memory. When the storage device 200 is an SSD, the storage device 200 may be a device that conforms to an NVMe standard. When the storage device 200 is an embedded memory or an external memory, the storage device 200 may be a device that conforms to a UFS standard or an eMMC standard. Each of the host 100 and the storage device 200 may generate a packet according to an adopted standard protocol and transmit the packet.

When the NVM 220 of the storage device 200 includes a flash memory, the flash memory may include a 2D NAND memory array or a 3D (or vertical) NAND (VNAND) memory array. As another example, the storage device 200 may include various other kinds of NVMs. For example, the storage device 200 may include magnetic RAM (MRAM), spin-transfer torque MRAM, conductive bridging RAM (CBRAM), ferroelectric RAM (FRAM), PRAM, RRAM, and various other kinds of memories.

According to an example embodiment, the host controller 110 and the host memory 120 may be implemented as separate semiconductor chips. Alternatively, in some example embodiments, the host controller 110 and the host memory 120 may be integrated in the same semiconductor chip. As an example, the host controller 110 may be any one of a plurality of modules included in an application processor (AP). The AP may be implemented as a System on Chip (SoC). Further, the host memory 120 may be an embedded memory included in the AP or an NVM or memory module located outside the AP.

The host controller 110 may manage an operation of storing data (e.g., write data) of a buffer region of the host memory 120 in the NVM 220 or an operation of storing data (e.g., read data) of the NVM 220 in the buffer region.

The storage controller 210 may include a host interface 211, a memory interface 212, and a CPU 213. Further, the storage controllers 210 may further include a flash translation layer (FTL) 214, a packet manager 215, a buffer memory 216, an error correction code (ECC) engine 217, and an advanced encryption standard (AES) engine 218. The storage controllers 210 may further include a working memory in which the FTL 214 is loaded. The CPU 213 may execute the FTL 214 to control data write and read operations on the NVM 220.

The host interface 211 may transmit and receive packets to and from the host 100. A packet transmitted from the host 100 to the host interface 211 may include a command or data to be written to the NVM 220. A packet transmitted from the host interface 211 to the host 100 may include a response to the command or data read from the NVM 220. The memory interface 212 may transmit data to be written to the NVM 220 to the NVM 220 or receive data read from the NVM 220. The memory interface 212 may be configured to comply with a standard protocol, for example, Toggle or open NAND flash interface (ONFI).

The FTL 214 may perform various functions, such as an address mapping operation, a wear-leveling operation, and a garbage collection operation. The address mapping operation may be an operation of converting a logical address received from the host 100 into a physical address used to actually store data in the NVM 220. The wear-leveling operation may be a technique for preventing excessive deterioration of a specific block by allowing blocks of the NVM 220 to be uniformly used. As an example, the wear-leveling operation may be implemented using a firmware technique that balances erase counts of physical blocks. The garbage collection operation may be a technique for ensuring usable capacity in the NVM 220 by erasing an existing block after copying valid data in the existing block to a new block.

The packet manager 215 may generate a packet according to a protocol of an interface, which consents to the host 100, or parse various types of information from the packet received from the host 100. In addition, the buffer memory 216 may temporarily store data to be written to the NVM 220 or data to be read from the NVM 220. Although the buffer memory 216 may be a component included in the storage controllers 210, the buffer memory 216 may be outside the storage controllers 210.

The ECC engine 217 may perform error detection and correction operations on read data read from the NVM 220. More specifically, the ECC engine 217 may generate parity bits for write data to be written to the NVM 220, and the generated parity bits may be stored in the NVM 220 together with write data. During the reading of data from the NVM 220, the ECC engine 217 may correct an error in the read data by using the parity bits read from the NVM 220 along with the read data, and output error-corrected read data.

The AES engine 218 may perform at least one of an encryption operation and a decryption operation on data input to the storage controllers 210 by using a symmetric-key algorithm.

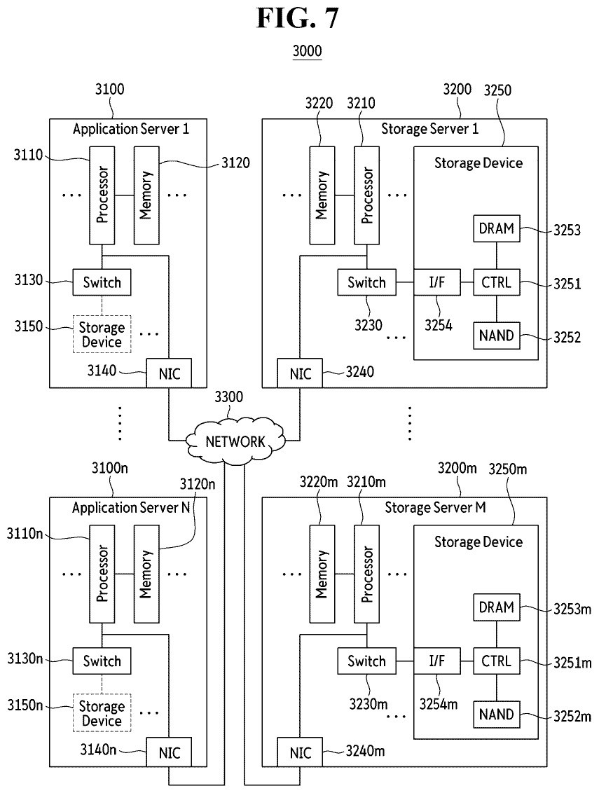

FIG. 7 is a schematic diagram illustrating a data center to which a storage device is applied according to one or more embodiments of the present disclosure.

### Platform Portion—Server (Application/Storage)

Referring to FIG. 7, the data center 3000 may be a facility that collects various types of pieces of data and provides services and be referred to as a data storage center. The data center 3000 may be a system for operating a search engine and a database, and may be a computing system used by companies, for example, banks, or government agencies. The data center 3000 may include application servers 3100 to 3100n and storage servers 3200 to 3200m. The number of application servers 3100 to 3100n and the number of storage servers 3200 to 3200m may be variously selected according to example embodiments. The number of application servers 3100 to 3100n may be different from the number of storage servers 3200 to 3200m.

The application server 3100 or the storage server 3200 may include at least one of processors 3110 and 3210 and memories 3120 and 3220. The storage server 3200 will now be described as an example. The processor 3210 may control all operations of the storage server 3200, access the memory 3220, and execute instructions and/or data loaded in the memory 3220. The memory 3220 may be a double-data-rate synchronous DRAM (DDR SDRAM), a high-bandwidth memory (HBM), a hybrid memory cube (HMC), a dual in-line memory module (DIMM), Optane DIMM, and/or a non-volatile DIMM (NVMDIMM). In some example embodiments, the numbers of processors 3210 and memories 3220 included in the storage server 3200 may be variously selected. In an example embodiment, the processor 3210 and the memory 3220 may provide a processor-memory pair. In an example embodiment, the number of processors 3210 may be different from the number of memories 3220. The processor 3210 may include a single-core processor or a multi-core processor. The above description of the storage server 3200 may be similarly applied to the application server 3100. In one or more embodiments, the application server 3100 may not include a storage device 3150. The storage server 3200 may include at least one storage device 3250. The number of storage devices 3250 included in the storage server 3200 may be variously selected according to embodiments.

### Platform Portion—Network

The application servers 3100 to 3100n may communicate with the storage servers 3200 to 3200m through a network 3300. The network 3300 may be implemented by using a fiber channel (FC) or Ethernet. In this case, the FC may be a medium used for relatively high-speed data transmission and use an optical switch with high performance and high availability. The storage servers 3200 to 3200m may be provided as file storages, block storages, or object storages according to an access method of the network 3300.

In an embodiment, the network 3300 may be a storage-dedicated network, such as a storage area network (SAN). For example, the SAN may be an FC-SAN, which uses an FC network and is implemented according to an FC protocol (FCP). As another example, the SAN may be an Internet protocol (IP)-SAN, which uses a transmission control protocol (TCP)/IP network and is implemented according to a SCSI over TCP/IP or Internet SCSI (iSCSI) protocol. In another embodiment, the network 3300 may be a general network, such as a TCP/IP network. For example, the network 3300 may be implemented according to a protocol, for example, FC over Ethernet (FCoE), network attached storage (NAS), and NVMe over Fabrics (NVMe-oF).

Hereinafter, the application server 3100 and the storage server 3200 will mainly be described. A description of the application server 3100 may be applied to another application server 3100n, and a description of the storage server 3200 may be applied to another storage server 3200m.

The application server 3100 may store data, which is requested by a user or a client to be stored, in one of the storage servers 3200 to 3200m through the network 3300. Also, the application server 3100 may acquire data, which is requested by the user or the client to be read, from one of the storage servers 3200 to 3200m through the network 3300. For example, the application server 3100 may be implemented as a web server or a database management system (DBMS).

The application server 3100 may access a memory 3120n or a storage device 3150n, which is included in another application server 3100n, through the network 3300. Alternatively, the application server 3100 may access memories 3220 to 3220m or storage devices 3250 to 3250m, which are included in the storage servers 3200 to 3200m, through the network 3300. Thus, the application server 3100 may perform various operations on data stored in application servers 3100 to 3100n and/or the storage servers 3200 to 3200m. For example, the application server 3100 may execute an instruction for moving or copying data between the application servers 3100 to 3100n and/or the storage servers 3200 to 3200m. In this case, the data may be moved from the storage devices 3250 to 3250m of the storage servers 3200 to 3200m to the memories 3120 to 3120n of the application servers 3100 to 3100n directly or through the memories 3220 to 3220m of the storage servers 3200 to 3200m. The data moved through the network 3300 may be data encrypted for security or privacy.

### Organic Relationship—Interface Structure/Type

The storage server 3200 will now be described as an example. An interface 3254 may provide physical connection between a processor 3210 and a controller 3251 and a physical connection between a network interface card (NIC) 3240 and the controller 3251. For example, the interface 3254 may be implemented using a direct attached storage (DAS) scheme in which the storage device 3250 is directly connected with a dedicated cable. For example, the interface 3254 may be implemented by using various interface schemes, such as ATA, SATA, e-SATA, an SCSI, SAS, PCI, PCIe, NVMe, IEEE 1394, a USB interface, an SD card interface, an MMC interface, an eMMC interface, a UFS interface, an eUFS interface, and/or a CF card interface.

The storage server 3200 may further include a switch 3230 and the NIC(Network InterConnect) 3240. The switch 3230 may selectively connect the processor 3210 to the storage device 3250 or selectively connect the NIC 3240 to the storage device 3250 via the control of the processor 3210.

In an embodiment, the NIC 3240 may include a network interface card and a network adaptor. The NIC 3240 may be connected to the network 3300 by a wired interface, a wireless interface, a Bluetooth interface, or an optical interface. The NIC 3240 may include an internal memory, a digital signal processor (DSP), and a host bus interface and be connected to the processor 3210 and/or the switch 3230 through the host bus interface. The host bus interface may be implemented as one of the above-described examples of the interface 3254. In an embodiment, the NIC 3240 may be integrated with at least one of the processor 3210, the switch 3230, and the storage device 3250.

### Organic Relationship—Interface Operation

In the storage servers 3200 to 3200m or the application servers 3100 to 3100n, a processor may transmit a command to storage devices 3150 to 3150n and 3250 to 3250m or the memories 3120 to 3120n and 3220 to 3220m and program or read data. In this case, the data may be data in which an error is corrected by an ECC engine. The data may be data on which a data bus inversion (DBI) operation or a data masking (DM) operation is performed, and may include cyclic redundancy code (CRC) information. The data may be data encrypted for security or privacy.

Storage devices 3150 to 3150n and 3250 to 3250m may transmit a control signal and a command/address signal to NAND flash memory devices 3252 to 3252m in response to a read command received from the processor. Thus, when data is read from the NAND flash memory devices 3252 to 3252m, a read enable (RE) signal may be input as a data output control signal, and thus, the data may be output to a DQ bus. A data strobe signal DQS may be generated using the RE signal. The command and the address signal may be latched in a page buffer depending on a rising edge or falling edge of a write enable (WE) signal.

### Product Portion—SSD Basic Operation

The controller 3251 may control all operations of the storage device 3250. In an embodiment, the controller 3251 may include SRAM. The controller 3251 may write data to the NAND flash memory device 3252 in response to a write command or read data from the NAND flash memory device 3252 in response to a read command. For example, the write command and/or the read command may be provided from the processor 3210 of the storage server 3200, the processor 3210m of another storage server 3200m, or the processors 3110 and 3110n of the application servers 3100 and 3100n. DRAM 3253 may temporarily store (or buffer) data to be written to the NAND flash memory device 3252 or data read from the NAND flash memory device 3252. Also, the DRAM 3253 may store metadata. Here, the metadata may be user data or data generated by the controller 3251 to manage the NAND flash memory device 3252. The storage device 3250 may include a secure element (SE) for security or privacy.

The data prefetching method and device according to embodiments of the present disclosure, by acquiring parameters of read requests for a storage device within a prefetching time window, wherein the parameters of the read requests include at least a feature of the read requests and logical block address information of the read requests, determining a prefetching quantity of subsequent read requests for the storage device, according to the feature of the read requests, determining the prefetching quantity of prefetching chunk addresses for the subsequent read requests, according to the logical block address information of the read requests, and prefetching data in the prefetching quantity of the prefetching chunk addresses of the storage device, thereby increasing the cache hit rate without increasing the computational resources.

Although the present disclosure has been specifically shown and described with reference to embodiments thereof, those skilled in the art should understand that various changes of the forms and details may be made without departing from the spirit and scope of the present disclosure as defined by the claims.

What is claimed is:

1. A data prefetching method comprising:
acquiring parameters of read requests for a storage device within a prefetching time window, wherein the parameters of the read requests comprise at least a feature of the read requests and logical block address information of the read requests;
determining, based on the feature of the read requests, a prefetching quantity of subsequent read requests for the storage device;
determining, based on the logical block address information of the read requests, a prefetching quantity of prefetching chunk addresses for the subsequent read requests; and
prefetching data in the prefetching quantity of the prefetching chunk addresses of the storage device.

2. The method according to claim 1,
wherein the parameters of the read requests further comprise heat information of the read requests, and
wherein the determining the prefetching quantity of the prefetching chunk addresses for the subsequent read requests comprises:
predicting an attribute of the subsequent read requests based on the logical block address information of the read requests; and
based predicting that the attribute of the subsequent read requests is a first attribute, predicting the prefetching quantity of the prefetching chunk addresses for the subsequent read requests by inputting the heat information of the read requests into a heat prediction model.

3. The method according to claim 2, wherein the predicting the prefetching quantity of the prefetching chunk addresses for the subsequent read requests by inputting the heat information of the read requests into the heat prediction model comprises:
predicting a heat of each chunk address of the storage device by inputting the heat information of the read requests into the heat prediction model;
sorting chunk addresses of the storage device in descending order based on a magnitude of the heat of each chunk address; and
using the prefetching quantity of the chunk addresses with a heat above a threshold, among the chunk addresses of the storage device, as the prefetching chunk addresses.

4. The method according to claim 2, wherein the determining the prefetching quantity of the prefetching chunk addresses for the subsequent read requests further comprises:
based on predicting that the attribute of the subsequent read requests is a second attribute, determining the prefetching quantity of the prefetching chunk addresses based on a subsequent logical block address of the logical block address information.

5. The method according to claim 1, further comprising:
determining a prefetching frequency of the subsequent read requests for the storage device based on the feature of the read requests,
wherein the prefetching of the data in the prefetching quantity of prefetching chunk addresses comprises:
prefetching the data in the prefetching quantity of the prefetching chunk addresses of the storage device based on the prefetching frequency.

6. The method according to claim 2, wherein the heat prediction model is obtained by training using the heat of the read requests for the storage device during a predetermined time period as training data.

7. A data prefetching device comprising:
a storage device,
memory storing one or more instructions; and
at least one processor configured to execute the one or more instructions, wherein the one or more instructions, when executed by the at least one processor, cause the data prefetching device to:
acquire parameters of read requests for the storage device within a prefetching time window, wherein the parameters of the read requests comprise at least a feature of the read requests and logical block address information of the read requests,
determine, based on the feature of the read requests, a prefetching quantity of subsequent read requests for the storage device,
determine, based on the logical block address information of the read requests, the prefetching quantity of prefetching chunk addresses for the subsequent read requests; and
prefetch data in the prefetching quantity of the prefetching chunk addresses of the storage device.

8. The data prefetching device of claim 7,
wherein the parameters of the read requests further comprise heat information of the read requests, and
wherein the one or more instructions, when executed by the at least one processor, cause the data prefetching device to:
predict an attribute of the subsequent read requests based on the logical block address information of the read requests, and
based predicting that the attribute of the subsequent read requests is a first attribute, predict the prefetching quantity of the prefetching chunk addresses for the subsequent read requests by inputting the heat information of the read requests into a heat prediction model.

9. The data prefetching device of claim 8, wherein the one or more instructions, when executed by the at least one processor, cause the data prefetching device to:
predict a heat of each chunk address of the storage device by inputting the heat information of the read requests into the heat prediction model,
sort the chunk addresses of the storage device in descending order based on a magnitude of the heat of each chunk address, and
use the prefetching quantity of the chunk addresses with a heat above a threshold, among the chunk addresses of the storage device, as the prefetching chunk addresses.

10. The data prefetching device of claim 8, wherein the one or more instructions, when executed by the at least one processor, cause the data prefetching device to:
based on predicting that the attribute of the subsequent read requests is a second attribute, determine the prefetching quantity of the prefetching chunk addresses based on a subsequent logical block address of the logical block address information.

11. The data prefetching device of claim 7, wherein the one or more instructions, when executed by the at least one processor, cause the data prefetching device to:
determine a prefetching frequency of the subsequent read requests for the storage device based on the feature of the read requests, and
prefetch the data in the prefetching quantity of the prefetching chunk addresses of the storage device based on the prefetching frequency.

12. The data prefetching device of claim 8, wherein the heat prediction model is obtained by training using the heat of the read requests for the storage device during a predetermined time period as training data.

13. A non-transitory computer readable storage medium having instructions stored therein, which when executed by at least one processor cause the at least one processor to execute a data prefetching method comprising:
acquiring parameters of a read requests for a storage device within a prefetching time window, wherein the parameters of the read requests comprise at least a feature of the read requests and logical block address information of the read requests;
determining, based on the feature of the read requests, a prefetching quantity of subsequent read requests for the storage device;
determining, based on the logical block address information of the read requests, a prefetching quantity of prefetching chunk addresses for the subsequent read requests; and
prefetching data in the prefetching quantity of the prefetching chunk addresses of the storage device.

14. The non-transitory computer readable medium of claim 13,
wherein the parameters of the read requests further comprise heat information of the read requests, and
wherein the determining the prefetching quantity of the prefetching chunk addresses for the subsequent read requests comprises:
predicting an attribute of the subsequent read requests based on the logical block address information of the read requests; and
based predicting that the attribute of the subsequent read requests is a first attribute, predicting the prefetching quantity of the prefetching chunk addresses for the subsequent read requests by inputting the heat information of the read requests into a heat prediction model.

15. The non-transitory computer readable medium of claim 14, wherein the predicting the prefetching quantity of the prefetching chunk addresses for the subsequent read requests by inputting the heat information of the read requests into the heat prediction model comprises:
predicting a heat of each chunk address of the storage device by inputting the heat information of the read requests into the heat prediction model;
sorting chunk addresses of the storage device in descending order based on a magnitude of the heat of each chunk address; and
using the prefetching quantity of the chunk addresses with a heat above a threshold, among the chunk addresses of the storage device, as the prefetching chunk addresses.

16. The non-transitory computer readable medium of claim 14, wherein the determining the prefetching quantity of the prefetching chunk addresses for the subsequent read requests further comprises:
based on predicting that the attribute of the subsequent read requests is a second attribute, determining the prefetching quantity of the prefetching chunk addresses based on a subsequent logical block address of the logical block address information.

17. The non-transitory computer readable medium of claim 13,
wherein the method further comprises:
determining a prefetching frequency of the subsequent read requests for the storage device based on the feature of the read requests, and
wherein the prefetching of the data in the prefetching quantity of prefetching chunk addresses comprises:
prefetching the data in the prefetching quantity of the prefetching chunk addresses of the storage device based on the prefetching frequency.

18. The non-transitory computer readable medium of claim 14, wherein the heat prediction model is obtained by training using the heat of the read requests for the storage device during a predetermined time period as training data.

19. A data center system comprising:
a plurality of application servers; and
a plurality of storage servers,
wherein each of the plurality of storage servers comprises:
a storage device;
memory storing one or more instructions; and
at least one processor configured to execute the one or more instructions, wherein the one or more instructions, when executed by the at least one processor of each of the plurality of storage servers, cause the plurality of storage servers to:
acquire parameters of read requests for the storage device of the respective storage server within a prefetching time window, wherein the parameters of the read requests comprise at least a feature of the read requests and logical block address information of the read requests,
determine, based on the feature of the read requests, a prefetching quantity of subsequent read requests for the storage device,
determine, based on the logical block address information of the read requests, the prefetching quantity of prefetching chunk addresses for the subsequent read requests; and
prefetch data in the prefetching quantity of the prefetching chunk addresses of the storage device.

20. The data center system of claim 19,
wherein the parameters of the read requests further comprise heat information of the read requests, and
wherein the one or more instructions, when executed by the at least one processor of each of the plurality of storage servers, cause the plurality of storage servers to:
predict an attribute of the subsequent read requests based on the logical block address information of the read requests, and
based predicting that the attribute of the subsequent read requests is a first attribute, predict the prefetching quantity of the prefetching chunk addresses for the subsequent read requests by inputting the heat information of the read requests into a heat prediction model.
